(19) United States
(12) Patent Application Publication
(10) Pub. No.: US 2001/0029762 A1
(43) Pub. Date: Oct. 18, 2001

(54) Soil amendment product and process

(75) Inventors: Richard Binion Steele, Arden, NC (US); Donald Frederick Evans, Raleigh, NC (US); Mark S. Booth, Matthews, NC (US); Malcolm J. Proper, Matthews, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Waste Reduction Products Corporation

(21) Appl. No.: 09/851,807

(22) Filed: May 9, 2001

Related U.S. Application Data
(63) Continuation of application No. 09/361,547, filed on Jul. 27, 1999.
Application No. 09/361,547 is a continuation of application No. 08/883,875, filed on Jun. 27, 1997, now abandoned.
(63) Continuation of application No. 09/261,512, filed on Mar. 3, 1999, now abandoned.
Application No. 09/261,512 is a continuation of application No. 08/771,476, filed on Dec. 24, 1996, now abandoned.
(60) Provisional application No. 60/020,755, filed on Jun. 28, 1996.

(51) Int. Cl. C05D 1/00; C01F 11/46

(52) U.S. Cl. 71/63; 423/555

(57) ABSTRACT

There is provided a soil amendment product of agglomerated or compacted calcined calcium sulfate. The soil amendment product is screened to a particle size between 6 mesh and about 100 mesh. In another aspect of the invention, an effective amount of a binder such as a clay, lignin or starch is added to the calcium sulfate to assist the calcium sulfate to pelletize. The pelletized calcium sulfate is sized and calcined. There is also disclosed processes for making the soil amendment products.

### CROSS-REFERENCE TO RELATED APPLICATION

This application claims the benefit of U.S. Provisional Application No. 60/020,755 filed Jun. 28, 1996.

### BACKGROUND OF THE INVENTION

1. Field of the Invention

The present invention relates to a soil amendment product and to processes for making the soil amendment product. More particularly, the present invention relates to a soil amendment product based on industrial waste gypsum or synthetic gypsum.

2. The Prior Art

Industrial wallboard (sheetrock) scrap and post industrial gypsum are considered waste products and disposal of these products is normally in landfills. Because these materials are waste products, attempts have been made to find new uses for the waste material. One such example is disclosed in U.S. patent application Ser. No. 08/719,953 filed Sep. 24, 1996 for an animal litter product and incorporated herein by reference.

While animal litter products have been found to be desirable, additional uses of waste gypsum products would further lessen the burden on landfill operations.

### SUMMARY OF THE INVENTION

It is an object of the present invention to provide a soil amendment product that can be spread using a conventional spreader and which can serve to enrich the soil and to act as a carrier for nutrients.

In accordance with the present invention, there is provided a soil amendment product which has been developed in response to growing environmental concerns about the disposal of waste materials and the desire to provide an inexpensive soil nutrient.

In its broadest aspects, the present invention provides a calcium sulfate based soil amendment product which is made by compacting waste calcium sulfate to increase the density or by adding a binder to the calcium sulfate powder and agglomerating or compacting. The materials which are primarily used to make the soil amendment of the present invention include waste gypsum from scrap wallboard, synthetic gypsum, and combinations of these materials. In the embodiment wherein the calcium sulfate is compacted it is passed through an extruder to increase the density to produce a product having the desired properties. The compacted calcium sulfate is then screened to a particle size range between a 4 mesh and about 100 mesh, U.S. sieve series, and dried. The most typical particle size is between 8 mesh and 40 mesh.

In another embodiment of the product of the present invention, it has been found that a soil amendment product having the desired properties may be made by adding to calcium sulfate an effective amount of a binder to agglomerate, thus forming pellets, pelletizing and calcining. Preferred binders include certain clays, especially bentonite clay, lignins and tarches. The effective amount of binder will depend upon the binder selected. For example, when bentonite clay is the binding agent, it may be present in an amount up to about 5.0%. Other binders will generally range in amounts from about 0.25% to about 10.0% by weight of the total composition, preferably from about 0.5% to about 2.0% by weight.

Another aspect of the present invention is to provide a process for producing the soil amendment product. In one of the processes of this invention, calcium sulfate is crushed and screened to a powder. A paste of powdered calcium sulfate is prepared and the paste is compacted by passing the paste through an extrusion mill at a pressure up to 1000 p.s.i., typically from about 300 p.s.i. to about 500 p.s.i., to form noodles which are broken into pellets. The compacted pellets are screened to the desired size to remove fines and oversized particles. Optionally, the pellets are then heated at a temperature from about 50° C. to about 430° C. until the calcium sulfate is calcined. A soil amendment product made according to this process does not require a binder because the compaction of the extrusion and the heating provide a calcined, hard product. However, when it is desirable to add a binder, such as when lower temperatures are used, the binder may be added when the paste is formed.

Alternatively, it has been found that the soil amendment product may be made by crushing waste gypsum, or synthetic gypsum to a powder, and optionally, screening to remove any paper backing. The powdered calcium sulfate is mixed with a dry binder prior to introduction onto a pelletizer or the binder is added by misting an aqueous solution containing the binder onto the powdered calcium sulfate in a pelletizer, pelletizing, screening to a predetermined size, and drying to calcine the pellets. Using this process the waste gypsum is not compressed.

The soil amendment of this invention, when spread onto land, is effective as a nutrient supplier.

Other objects, features and advantages of the present invention will be apparent from the following detailed description of the invention.

### DETAILED DESCRIPTION OF THE INVENTION

The present invention now will be described more fully hereinafter. This invention may, however, be embodied in many different forms and should not be construed as limited to the embodiments set forth herein; rather, these embodiments are provided so that this disclosure will be thorough and complete, and will fully convey the scope of the invention to those skilled in the art.

The soil amendment product of the present invention is substantially dust free, environmentally safe and effective. In its broadest aspects the soil amendment is made from calcium sulfate. The materials which are preferably used to make the soil amendment product of the present invention include waste gypsum, such as wallboard scrap, synthetic gypsum and combinations of both.

In one aspect of the invention, the gypsum may be separated from wallboard, i.e., the paper having been removed, or from whole wallboard, e.g., the gypsum and paper being ground together and both being incorporated into the soil amendment product. The drywall sheetrock or wallboard scrap is collected at construction sites and hauled to a process yard where this scrap is crushed and screened to separate the paper from the gypsum (calcium sulfate) core. The gypsum granules enter a mixing system and proceed to a pelletizing process and on to an industrial dryer.

In another aspect of this invention, synthetic gypsum may be, for example, waste or by-product gypsum from various industrial processes such as flue gas desulphurization. The synthetic gypsum (calcium sulfate) is delivered to a manufacturing system conveyance where a bonding agent may be mixed with the powder as it feeds into a pug mill where it is extruded and passes through a rotating blade and is cut into micro granules. Granules are formed in sizes consistent with that needed to be spread through conventional spreaders.

Access to calcined gypsum by reclaimed drywall scrap from the construction waste stream and calcium sulfate reclaimed from industrial waste provides an economical solution to the manufacture of a soil amendment product, either individually or through blending during the mixing process. The reclaimed calcium sulphate granules have been developed to respond to a growing demand to reduce the amount of materials going into landfills and to provide a product for agricultural and lawn and garden application.

In one embodiment, the soil amendment has been made by simply separating the gypsum from wallboard and grinding and screening it to an optimal particle size range, compacting, forming pellets, screening and calcining. The calcium sulfate is stabilized by compacting the calcium sulfate to increase its density by passing the calcium sulfate powder through an extruder. The damp formed granules (pellets) are discharged onto a conveyor belt which introduces the granules to an industrial dryer system. The dryer system uses heated air to dry the pellets in suspension until all moisture is eliminated which allows the granule to exit the dryer by convected air. The dried pellets are conveyed to shaker tables where screens size the product for packaging. It has been found that a soil amendment having the desired properties is formed at extrusion pressures up to about 1000 p.s.i., preferably a pressure between 300 p.s.i. and 500 p.s.i. The compacted material is screened to a particle size between 4 mesh and about 100 mesh, preferably between 8 mesh and 40 mesh, U.S. sieve series. The size of the particles desired will be determined by the intended end use, but shall be of such size as to pass through a conventional spreader.

The pellets are dried sufficiently to be converted into a hemihydrate (one molecule of H₂O for each molecule of CaSO₄) form of calcium sulfate or the anhydride form (no water molecules). These hemihydrate and/or anhydride granules are essentially plasters (Plaster of Paris) and with the addition of water or urine they clump together encapsulating the waste. The process of removing these chemically bound water molecules is known as calcination. The calcination process which removes impurities and moisture that are traditionally inherent in other forms of gypsum is usually two to one in purity over that of its counterpart. The temperature needed to begin calcination of gypsum dihydrite (two water molecules) is about 50° C. At about 150° C., conversion to the anhydride form takes place, however, at this low temperature level this anhydride form of gypsum is known as soluble anhydride and is somewhat unstable, that is, it will tend to absorb water out of the air and convert to a hemihydrate.

In another embodiment of the soil amendment product, a binder is added to the calcium sulfate to assist in pellet formation. It has been found that effective binders may include, for example, clays, lignins, starches, gums, cellulosic ethers, and water-soluble polymers. Although the amount of binder will vary depending upon the binder, it is preferable to use an amount of binder necessary to promote the desired pellet formation.

When a clay is the binder, typical clays include montmorillonite, kaolin, illite, halloysite, vermiculite, attapulgite, seppiolite, smectite, fuller's earth and the like. The bentonite clays are preferred for their absorbing and binding properties, especially the sodium and calcium bentonites (clays largely composed of montmorillonite but which can also contain beidellite, attapulgite, and similar minerals). When the clay binder is bentonite clay, it may be mixed with the calcium sulfate in amounts up to about 5.0% by weight, preferably from about 0.5% by weight to about 2.0% by weight. Other clay binders may be used in amounts up to about 10.0% by weight.

Another suitable class of binders are lignin binders. Lignin is a polymeric substance composed of substituted aromatics primarily obtained as a by-product of the pulp and paper industry from the residual pulping liquors. Lignin obtained by any pulping method or from any source may be used in the process of this invention as long as the lignin is in a form which becomes soluble in water, such as lignosulfates and sulfonated lignin. Among the lignins which may be used as binders are calcium lignosulfonate, sulfonated lignin, such as sodium sulfonated lignin, POLYFON F® and sulfonated alkali lignin, REAX® 80C. These lignin are available from Westvaco Corporation, North Charleston, S.C. When a lignin is the binder, it may be used in amounts up to about 5.0% by weight (solids), preferably from about 1.5% to about 3.0% by weight (solids).

Other binders include water-soluble cellulosic ethers, such as carboxymethyl-cellulose. When cellulose ethers are used as the binder, they may be added to the calcium sulfate in an amount up to about 2.0% by weight, preferably in an amount up to about 1.0% by weight. In addition, starches, such as wheat paste; gums, such as xanthin gum, guar gum; alginates; and water-soluble polymers such as polyvinyl pyrrolidone and polyvinyl alcohol are useful water-soluble binders. These binders may be used in amounts up to 5.0% by weight. To include amounts of these binders above about 5.0% does not increase the desired properties of the pellets to any appreciable extent.

The soil amendment product may also include trace additives such as nutrients which benefit the soil. These trace additives may be present in the soil amendment in amounts up to about 5.0% by total weight of the soil amendment, preferably from 1.5% to 4.0% by weight.

Another aspect of the present invention is to provide a process for producing the soil amendment product.

In one preferred process, waste gypsum, synthetic gypsum or a combination thereof is processed to a powder form and the gypsum powder is conveyed to a mixing station where a paste is formed with water. The paste will generally have from 10% by weight to about 30% by weight water. The calcium sulfate paste is compacted by extruding the paste through the die of, for example, a pug mill, to create a compacted form, usually a noodle, under either ambient or de-airing conditions. The materials are compacted at a pressure up to 1000 p.s.i., preferably between about 300 and 500 p.s.i. Pressures of this magnitude will tightly compress the calcium sulfate making a very high quality product. One aspect of the soil amendment is its durability or its tendency to resist degradation into dust before spreading.

The noodles obtained directly from the extruder die are generally not useful sizes to pass through the openings of a conventional spreader. Therefore, the noodles are broken down into pellets which are screened to remove fines and oversized particles which can then be recycled. Size reduction can be accomplished by a variety of methods and at different stages of the process after extrusion. The most direct method of size reduction is to shred the noodles with a rotating blade right at the die. The fineness of the granules and the particle size distribution depends upon the size of the die opening, the speed of the cutter, the number of blades on the cutter, and how closely the cutter blade is positioned to the exit surface of the die.

Size reduction can also be achieved with several type of separate grinding apparatus. A third option is to use both a die mounted fly cutter in conjunction with an auxiliary shredder. Depending upon the material mix and the size reduction method, it may be desirable to have an intermediate drying step to bring the compacted noodles to an optimum moisture content for grinding in order to produce the best granular material with the least amount of rejects. Usually it is necessary and desirable to bring the material to a moderately dry state where it ceases to deform plastically and will crush or break to make granules without producing dust. Optionally, a binder such as those described above may be added to the paste.

The pellets are then dried at a temperature from about 50° C. to about 430° C. until the gypsum is calcined. The drying temperature will depend upon the type of drying equipment used, such as a rotary dryer or a fluid bed dryer.

In another embodiment of the process of this invention, the gypsum powder, as described above, is conveyed to a mixing station where a binder is dry mixed with the gypsum or the binder is misted onto the gypsum powder as it is introduced to a pelletizer, such as a rotating disc pelletizer, pin mixer, rotary drum or the like, to form pellets. The pellets are discharged from the pelletizer onto a conveyor belt which introduces the pellets to a sizing screen and/or a dryer, such as a rotary dryer. The dryer in rotation tumbles the pellets at a temperature from about 50° C. to about 430° C. until the gypsum is calcined.

The water soluble characteristics of the soil amendment product of this invention allows it to become an agriculturally valuable product. Thus, disposal of a waste can be accomplished by spreading it on land since it makes a good fertilizer.

While the present invention has been described in connection with the exemplary embodiments thereof, it will be understood that any modification will be apparent to those of ordinary skill in the art and that this application is intended to cover any adaptations or variations thereof. Therefore, it is intended that this invention be limited only by the claims and equivalents thereof.

That which is claimed is:

1. A soil amendment product comprising a calcium sulfate, said calcium sulfate having been compacted at a pressure up to about 1000 p.s.i., said compacted calcium sulfate having a particle size between 4 mesh and about 100 mesh.

2. The soil amendment product according to claim 1 wherein said calcium sulfate is post industrial waste gypsum.

3. The soil amendment product according to claim 1 wherein said calcium sulfate is synthetic industrial gypsum.

4. The soil amendment product according to claim 1 wherein said calcium sulfate has been compacted at a pressure between about 300 p.s.i. and 500 p.s.i.

5. The soil amendment product according to claim 1 wherein said compacted calcium sulfate has a particle size between 8 mesh and 40 mesh.

6. The soil amendment product according to claim 1 further comprising an effective amount of a binder to cause said calcium sulfate to pelletize, said calcium sulfate absorbent and said binder being pelletized, said pellets having been screened to a particle size range between 4 mesh and 100 mesh.

7. The soil amendment product according to claim 6 wherein said binder is a clay and is present in an amount from about 0.25% to about 10.0% by weight.

8. The soil amendment product according to claim 6 wherein said clay is a bentonite clay and is present in an amount from about 0.5% to about 2.0% by weight.

9. The soil amendment product according to claim 6 wherein said binder is a water-soluble lignin and is present in an amount up to about 5.0% by weight.

10. The soil amendment product according to claim 6 wherein said binder is a member of the group consisting of water-soluble cellulosic ethers, alginates, starches, gums, polyvinyl pyrrolidone, and polyvinyl alcohol.

11. The soil amendment product according to claim 6 wherein said binder is carboxymethylcellulose and is present in an amount up to about 1.0%.

12. The soil amendment product according to claim 6 wherein said binder is a member of the group consisting of wheat paste, xanthin gum and guar gum.

13. A process for producing a soil amendment product comprising:
crushing and screening calcium sulfate to a powder;
forming a paste of said calcium sulfate;
compacting said paste by extrusion through an extrusion mill and forming pellets;
screening said pellets to a predetermined particle size; and
drying said pellets until the calcium sulfate is at least partially calcined.

14. The process according to claim 13 wherein said calcining is performed at a temperature between about 50° C. and about 430° C.

15. The process according to claim 13 further comprising mixing said powdered calcium sulfate with an effective amount of a binder aid in compaction.

16. The process according to claim 13 wherein said calcium sulfate is drywall scrap that has been ground and screened to separate paper therefrom.

17. The process according to claim 15 wherein said binder is a bentonite clay and is present in an amount from about 0.5% to about 2.0% by weight.

18. The process according to claim 15 wherein said binder is a water-soluble lignin and is present in an amount up to about 5.0% by weight.

19. A process for producing a soil amendment product comprising:
crushing and screening calcium sulfate to a powder;
adding an effective amount of binder to said calcium sulfate powder to cause agglomeration of said calcium sulfate;
agglomerating said calcium sulfate to form pellets;
screening said pellets to a predetermined particle size; and
drying said pellets until the calcium sulfate is at least partially calcined.

20. The process according to claim 19 wherein said binder is bentonite clay and is present in an amount up to 5.0% by weight.
